(19) United States
(12) Patent Application Publication
(10) Pub. No.: US 2012/0302693 A1
(43) Pub. Date: Nov. 29, 2012

(54) FLUORINE CONTAINING GRAFT COPOLYMER COATING COMPOSITION

(75) Inventors: ROBERT C NAHAS, Voorhees, NJ (US); Andrew P Stamegna, Wilmington, DE (US)

(73) Assignee: E I DU PONT DE NEMOURS AND COMPANY, Wilmington, DE (US)

(21) Appl. No.: 13/477,450

(22) Filed: May 22, 2012

Related U.S. Application Data
(60) Provisional application No. 61/488,910, filed on May 23, 2011.

(51) Int. Cl. C09D 151/06; C09D 133/16

(52) U.S. Cl. 524/504; 524/544

(57) ABSTRACT

The present disclosure relates to a coating composition comprising a fluoropolymer, especially a fluorine containing graft copolymer. A dried and cured layer of the coating composition can provide a substrate with an easy to clean surface having a high water contact angle and good recoat adhesion.

### CROSS-REFERENCE TO RELATED APPLICATION

This application claims priority under 35 U.S.C. §119 from U.S. Provisional Application Ser. No. 61/488,910, filed May 23, 2011.

### FIELD OF THE DISCLOSURE

The present disclosure is directed to a coating composition comprising a fluorine containing graft copolymer. The coating composition provides a layer of a dried and optionally cured coating composition that has a high water contact angle and an easy to clean surface and has good recoat adhesion.

### BACKGROUND OF DISCLOSURE

Coating compositions containing fluorocarbon polymers are known. Such coating compositions are said to remain relatively dirt free during use and to provide easy to clean surfaces. The coatings are also said to have high water and oil repellency and are useful as clearcoats, especially in the automotive industry. Fluorinated acrylic polymers and fluorinated polyurethanes are commonly cited as being useful.

Fluorine containing coating compositions can be difficult to repair due to the low surface energy provided by the fluorine atoms which are known to migrate to the surface (opposite the substrate) of an applied layer of the coating composition and form relatively large domains of fluorine. Some fluorine containing coating compositions comprise non-fluorinated polymers and have added relatively low molecular weight fluorine containing additives. These fluorine containing additives tend to migrate to the surface providing a surface that has a relatively thin layer of a concentrated fluorine domain covering a majority of the surface. This thin layer can wear away over time and the effects are lost. Regardless of the methods used to provide fluorine to the coating compositions, the low surface energy of the fluorine domains at the surface can result in low adhesiveness to subsequently applied coatings, such as, for example, repair coatings. It has also been known to add adhesion promoting additives to fluoropolymer containing clearcoat compositions and/or to the underlying basecoat compositions in order to provide the cured coating with adequate adhesion in case the fluorine containing coating becomes damaged and needs to be repaired.

There is an ongoing need for a coating composition that provides not only an easy to clean, durable finish, but also one that can easily be repaired in the event that the coating becomes damaged.

### STATEMENT OF THE DISCLOSURE

The present disclosure relates to a coating composition comprising A) a fluorine containing graft copolymer wherein the fluorine containing graft copolymer comprises:
i) in the range of from 0.5 to 20 percent by weight of fluorine, based on the total weight of the fluorine containing graft copolymer,
ii) in the range of from 0 to 100 percent by weight of fluorine on the side chains, based on the total weight of fluorine in the fluorine containing graft copolymer,
iii) in the range of from 10 to 100 percent by weight of hydroxyl groups on the backbone, based on the total weight of hydroxyl groups in the fluorine containing graft copolymer, and
iv) in the range of from 5 to 50 percent by weight of side chains based on the total weight of the fluorine containing graft copolymer.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

The phrase “fluorine containing graft copolymer” means a copolymer that has a backbone and side chains attached to the backbone and also contains one or more fluorine atoms wherein the fluorine atoms are attached to the backbone, attached to the side chains or attached to both the backbone and the side chains. In some embodiments, the fluorine containing graft copolymer is a (meth)acrylic graft copolymer that can be produced by the polymerization of a monomer mixture wherein the monomer mixture comprises a macromonomer and (meth)acrylic monomers. The (meth)acrylic monomers form the backbone and the macromonomers form the side chains of the fluorine containing graft copolymer. Fluorine containing linear copolymers are excluded from this disclosure.

The macromonomer comprises a copolymer having a single ethylenically unsaturated carbon-carbon double bond per molecule that can subsequently be polymerized via known free radical or anionic polymerization conditions with the other monomers in the monomer mixture to form the desired fluorine containing graft copolymer. In some embodiments, the ethylenically unsaturated carbon-carbon double bond is in a terminal position. Methods of forming macromonomers using catalysts and/or chain transfer agents are well-known in the art. Suitable methods can include, for example, Reversible Addition-Fragmentation chain Transfer polymerization (RAFT), Group Transfer Polymerization (GTP) and Cobalt mediated chain transfer polymerization.

As used herein, the phrase “clearcoat composition” refers to the state of a dried and cured layer of the applied clearcoat composition. The clearcoat composition, before drying and curing, can be transparent, translucent or opaque.

As used herein, (meth)acrylic means acrylic and/or methacrylic and (meth)acrylate means acrylate and/or methacrylate.

As used herein, the “surface of an applied layer of the coating composition” refers to the surface opposite the substrate to which the coating composition has been applied.

The phrase “essentially free from” means that a composition contains less than 5 percent by weight of a given moiety. In some embodiments, the composition contains less than 2 percent and in still further embodiments, the composition contains less than 0.5 percent by weight of a given moiety.

As used herein, the phrase “relatively uniformly distributed” means that a section of a sample, for example, the two dimensional surface of a dried and cured layer of a coating composition or a three dimensional section of the interior of a dried and cured layer of a coating composition, when imaged with various techniques including, for example, Atomic Force Microscopy, shows a structure wherein a statistical analysis of a given portion of the sample image results in a distribution of structures within the portion that does not vary by more than 20% when compared with a second, different portion of the image.

The present disclosure relates to a coating composition comprising A) a fluorine containing graft copolymer as a film forming binder. The coating composition can be a lacquer or it can be cured to form a crosslinked network. As is known in the art, a lacquer is a coating composition that dries by solvent evaporation and the film forming binder does not form irreversible or covalent bonds with itself or other film forming binders that may be present. A crosslinked system comprises one or more film forming binders that can interact or react with one another to form covalent bonds. If the coating composition is a crosslinked system, the coating composition can comprise a crosslinkable component and a crosslinking component. The crosslinkable component can comprise crosslinkable functional groups, for example, hydroxyl functional groups, amine functional groups, epoxy functional groups, carboxyl functional groups, silane functional groups or a combination thereof. In some embodiments, the crosslinkable functional groups are hydroxyl groups. The crosslinking component is a compound, polymer or copolymer having functional groups that are able to react with the crosslinkable functional groups of the crosslinkable component. The compounds, polymers or copolymers can include polyisocyanates, blocked polyisocyanates, amine resins, compounds, polymers or copolymers containing carboxyl or anhydride groups. In some embodiments, the crosslinking component comprises or consists essentially of polyisocyanates.

The fluorine containing graft copolymer can be produced by the polymerization of a monomer mixture wherein the monomer mixture comprises a macromonomer and one or more other monomers. In some embodiments, the monomer mixture can comprise in the range of from 5 to 50 percent by weight of the macromonomer, based on the total weight of the monomer mixture. In still further embodiments, the monomer mixture can comprise in the range of from 10 to 40 percent by weight of the macromonomer and in still further embodiments, the monomer mixture can comprise in the range of from 15 to 35 percent by weight of the macromonomer wherein the percentages by weight are based on the total amount of the monomer mixture.

In some embodiments, the other monomers present in the monomer mixture can include, for example, methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, pentyl (meth)acrylate, hexyl (meth)acrylate, octyl (meth)acrylate, nonyl (meth)acrylate, decyl (meth)acrylate, lauryl (meth)acrylate, stearyl (meth)acrylate, styrene, alpha methyl styrene, (meth)acrylamide, (meth)acrylonitrile, hydroxy (meth)acrylamide; hydroxy alkyl (meth)acrylates, hydroxy ethyl (meth)acrylate, hydroxy propyl (meth)acrylate, hydroxy butyl (meth)acrylate; trialkoxysilyl alkyl (meth)acrylates, trimethoxysilyl propyl (meth)acrylate, triethoxysilyl propyl (meth)acrylate, vinyl trialkoxy silane, vinyl trimethoxy silane, vinyl triethoxy silane, glycidyl (meth)acrylate, (meth)acrylic acid, aminoalkyl (meth)acrylates, N-alkyl aminoalkyl (meth)acrylates, N,N-dialkyl aminoalkyl (meth)acrylates, ether and polyether extended alkyl (meth)acrylates, 2-ethoxy ethyl (meth)acrylate, 2-butoxy ethyl (meth)acrylate, poly(ethylene glycol) (meth)acrylate, polyester extended (meth)acrylate esters, caprolactone-extended hydroxyalkyl (meth)acrylates or a combination thereof.

In some embodiments, the macromonomer and/or the other monomers comprise a fluorine atom wherein the total weight of fluorine in the fluorine containing graft copolymer is in the range of from 0.5 to 20 percent by weight, based on the total weight of the fluorine containing graft copolymer. In other embodiments, the total weight of fluorine in the fluorine containing graft copolymer is in the range of from 1 to 18 percent by weight and in still further embodiments the total weight of fluorine in the fluorine containing graft copolymer is in the range of from 2 to 15 percent by weight, wherein the percentages by weight are based on the total weight of the fluorine containing graft copolymer. The calculation of the percent by weight of fluorine in the fluorine containing graft copolymer is based on the total weight of fluorine in the monomer mixture and assumes that 100 percent of the monomer mixture is polymerized to become a part of the fluorine containing graft copolymer. It can be possible that a small percentage (preferably less than 5 percent by weight) of monomers in the monomer mixture remain unpolymerized.

In some embodiments, the macromonomer can be produced by the polymerization of (meth)acrylic monomers according to known methods wherein the macromonomers comprise one terminal ethylenically unsaturated carbon-carbon double bond. In some embodiments, the macromonomer can be produced via known RAFT, GTP or cobalt-mediated polymerization processes. In other embodiments, the terminal ethylenically unsaturated carbon-carbon double bond can be added by the reaction of a compound containing an ethylenically unsaturated carbon-carbon double bond with a preformed polymer. For example, a polymer having a terminal hydroxyl group could be reacted with acrylic acid or methacrylic acid under esterification conditions. In another example, an isocyanate terminated polymer could be reacted with 2-hydroxyethyl (meth)acrylate to produce the desired macromonomer.

The macromonomer can comprise in the range of from 0 to 100 percent by weight of the fluorine based on the total weight of fluorine in the fluorine containing graft copolymer. In some embodiments, the macromonomer can comprise in the range of from 10 to 90 percent by weight of the fluorine and in still further embodiments, the macromonomer can comprise in the range of from 20 to 80 percent by weight of fluorine, wherein the percentages by weight are based on the total weight of fluorine in the fluorine containing graft copolymer. In some embodiments, the fluorine containing graft copolymer can further comprise hydroxyl functional groups wherein the macromonomer can comprise in the range of from 0 to 90 percent by weight of the hydroxyl functional groups, based on the total weight of the hydroxyl functional groups in the fluorine containing graft copolymer. In some embodiments, the macromonomer can comprise in the range of from 5 to 60 percent by weight of hydroxyl functional groups and in still further embodiments, the macromonomer can comprise in the range of from 10 to 50 percent by weight of hydroxyl groups, wherein the percentages by weight are based on the total weight of hydroxyl groups in the fluorine containing graft copolymer. The calculation of the percent by weight of the fluorine and/or hydroxyl functional groups is based on the amount of said groups in the monomers that form the macromonomer and assumes that all of the monomers form the desired macromonomer.

Useful fluorinated monomers that can be used in the formation of the macromonomer and/or as a portion of the other monomers in the monomer mixture can include, for example, fluorine containing monomers having a structure according to structure (I):

CH₂═CR—C(O)O—(CH₂)ₙ—R_{f} (I)

wherein R is hydrogen or methyl, n is an integer in the range of from 0 to 20, and R_{f} is a fluoroalkyl group having in the range of from 1 to 20 carbon atoms. In one embodiment, R is methyl, n is 2 and R_{f} is C₆F₁₃ which is commercially available as CAPSTONE™ 62-MA, from DuPont, Wilmington, Del. Examples of suitable fluorine containing monomers according to formula (I) can include, for example, perfluoromethyl ethyl (meth)acrylate, perfluoroethyl ethyl (meth)acrylate, perfluorobutyl ethyl (meth)acrylate, perfluoropentyl ethyl (meth)acrylate, perfluorohexyl ethyl (meth)acrylate, perfluorooctyl ethyl (meth)acrylate, perfluorodecyl ethyl (meth)acrylate, perfluorolauryl ethyl (meth)acrylate, perfluorostearyl ethyl (meth)acrylate or combinations thereof. Other fluorinated monomers are known in the art and can be used.

The macromonomer can further comprise monomers such as, for example, methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, pentyl (meth)acrylate, hexyl (meth)acrylate, octyl (meth)acrylate, nonyl (meth)acrylate, decyl (meth)acrylate, lauryl (meth)acrylate, stearyl (meth)acrylate, styrene, alpha methyl styrene, (meth)acrylamide, (meth)acrylonitrile, hydroxy (meth)acrylamide; hydroxy alkyl (meth)acrylates, hydroxy methyl (meth)acrylate, hydroxy ethyl (meth)acrylate, hydroxy propyl (meth)acrylate, hydroxy butyl (meth)acrylate; trialkoxysilyl alkyl (meth)acrylates, trimethoxysilyl propyl (meth)acrylate, triethoxysilyl propyl (meth)acrylate, vinyl trialkoxy silane, vinyl trimethoxy silane, vinyl triethoxy silane, glycidyl (meth)acrylate, (meth)acrylic acid, aminoalkyl (meth)acrylates, N-alkyl aminoalkyl (meth)acrylates, N,N-dialkyl aminoalkyl (meth)acrylates, ether and polyether extended alkyl (meth)acrylates, 2-ethoxy ethyl (meth)acrylate, 2-butoxy ethyl (meth)acrylate, poly(ethylene glycol) (meth)acrylate, polyester extended (meth)acrylate esters, caprolactone-extended hydroxyalkyl (meth)acrylates or a combination thereof.

The fluorine containing graft copolymer can be produced by forming a monomer mixture comprising the macromonomer and other monomers, optionally in a liquid carrier. The other monomers can comprise any of those monomers previously listed. Polymerization of the monomer mixture can be done using typical free radical reaction conditions. In some embodiments, a free radical initiator can be added to a liquid carrier, optionally heating the free radical initiator and the liquid carrier to a polymerization temperature and then adding the monomer mixture in a liquid carrier to the free radical initiator mixture. The addition of the monomer mixture can be done all at once or over a specified period of time ranging from less than one minute to 24 hours. Once the monomer mixture has been added, the reaction can be maintained at a polymerization temperature until the desired fluorine containing graft copolymer has been formed. In other embodiments, the free radical initiator in a liquid carrier can be added portionwise or over a specified period of time to the monomer mixture in a liquid carrier. Typically, the polymerization temperature can be in the range of from 25° C. to 180° C.

The liquid carriers for the free radical initiator and for the monomer mixture can be the same or different. In some embodiments, the liquid carriers can include, for example, esters such as, butyl acetate, methyl acetate; saturated hydrocarbons, such as hexane, heptane; aromatics, such as toluene, xylene, SOLVESSO™ aromatic solvents, available from ExxonMobil, Houston, Tex.; ketones, such as methyl amyl ketone, methyl ethyl ketone, methyl isobutyl ketone; ethers, such as CARBITOL™ and CELLOSOLVE™ solvents, available from Dow, Midland, Mich., ethylene glycol monobutyl ether, or combinations thereof.

The free radical initiator can be any free radical initiator that is known in the art. Useful free radical initiators can include, for example, azo type initiators such as azo-bis-isobutyronitrile, 1,1′-azo-bis(cyanocyclohexane), 2,2′-azobis(2-methylbutyronitrile), peroxy acetates such as t-butyl peracetate, peroxides such as di-t-butyl peroxide, benzoates such as t-butyl perbenzoate, and octoates such as t-butyl peroctoate.

The coating composition can comprise A) the fluorine containing graft copolymer and optionally B) a polymer that is different from the fluorine containing graft copolymer. In some embodiments, the polymer B) can comprise or consist essentially of (meth)acrylic polymers, polyesters, polyurethanes, polyesterurethanes, polyetherurethanes, polyethers and a combination thereof. In some embodiments, the copolymer B) is a (meth)acrylate copolymer that is free from or essentially free from fluorine. In further embodiments, the copolymer B) contains one or more crosslinkable functional groups. In still further embodiments, the copolymer B) comprises hydroxyl functional groups. In general, there is no particular limitation to the copolymer B) except that the copolymer B) is not a non aqueous dispersion. The weight ratio of A:B in the coating composition can be in the range of from 1:99 to 99:1. In further embodiments, the weight ratio of A:B can be in the range of from 1:99 to 25:75 and in even further embodiments, the weight ratio of A:B can be in the range of from 2:98 to 20:80.

The coating composition can comprises a crosslinkable component which comprises A) the fluorine containing graft copolymer and B) a copolymer that is different from A). In some embodiments, the coating composition can further comprise a crosslinking component. The crosslinking component a compound, polymer or copolymer having functional groups that are able to react with the crosslinkable functional groups of the crosslinkable component. The compounds, polymers or copolymers can include polyisocyanates, blocked polyisocyanates, amine resins, compounds, polymers or copolymers containing carboxyl or anhydride groups. In some embodiments, the coating composition is essentially free from a fluorine containing blocked polyisocyanate. The coating composition can comprise in the range of from 10 to 60 percent by weight of the crosslinking component based on the total weight of the crosslinkable and crosslinking components. In other embodiments, the coating composition can comprise in the range of from 15 to 50 percent by weight of the crosslinking component, and in still further embodiments, the coating composition can comprise in the range of from 20 to 45 percent by weight of the crosslinking component, wherein the percentages by weight are based on the total weight of the crosslinkable and crosslinking components.

The coating composition can further comprise additives that are common in the art. Typical additives include, for example, organic solvents, light stabilizers, rheology control agents, defoamers, crosslinking catalysts or a combination thereof. Suitable solvents can include, for example, any of those solvents listed as being useful for the polymerization of the fluorine containing graft copolymer. Light stabilizers can include, for example, hydroxy dodecyl oxy benzophenone, 2,4-dihydroxy benzophenone, hydroxy benzophenones containing sulfonic acid groups, dibenzoate of diphenylol propane, tertiary butyl benzoate of diphenylol propane, 3,5-dialkyl-4-hydroxy phenyl derivatives of triazine, sulfur containing derivatives of dialkyl-4-hydroxy phenyl triazine, hydroxy phenyl-1,3,5-triazine, 2-phenyl-4-(2,2′-dihydroxybenzoyl)-triazole, substituted benzotriazoles such as hydroxy-phenyltriazole, bis(1,2,2,6,6 pentamethyl-4-piperidinyl sebacate), di[4(2,2,6,6, tetramethyl piperidinyl)]sebacate and combinations thereof. Rheology control agents can include, for example, diurea compounds, polyacrylic acid, polyalkylacrylates, polyether modified dimethyl polysiloxane copolymers and polyester modified polydimethyl siloxane. Suitable catalysts can include, for example, triethylene diamine and alkyl tin esters such as dibutyl tin dilaurate, dibutyl tin diacetate, tertiary amines.

When the coating composition is used as a clearcoat composition, it can be applied to a layer of dried and cured basecoat composition or it can be applied to a layer of a flash dried basecoat composition. As used herein, flash dried means that the applied layer of coating composition has been subjected to a drying step that removes at least a portion of the solvent, but does not result in curing of the coating composition. Typical application processes include any of the known application methods, such as, for example electrostatic spraying, high volume low pressure spraying, low pressure low volume spraying, pneumatic spraying; roll coating, flow coating and dip coating.

Once the coating or coatings have been applied, the coating can be dried and cured at room temperature or the applied layer of coating composition can be subjected to elevated temperatures to dry and cure the coating. Elevated curing temperatures can be in the range of from 30° C. to 180° C. Optionally, the applied layer of coating composition can be flash dried prior to curing.

It has been found the curing temperature and the concentration of both the fluorine atoms and hydroxyl functional groups on the backbone and side chains of the fluorine containing graft copolymer can play an important part in the domain structure of the cured coating composition. Without wishing to be bound by theory, it is believed that a layer of the dried and cured coating composition according to the present disclosure provides the surface of the dried and cured coating composition with a relatively uniformly distributed structure of fluorinated domains and non-fluorinated domains on the surface of an applied layer of the coating composition. It is further believed that this relatively uniformly distributed domain structure occurs not only on the surface but throughout the bulk layer of the applied coating composition. These domains are relatively small, on the order of 25 nanometers (nm) to 250 nm. Atomic Force Microscopy has been used to image the surface of an applied layer of the coating composition and can be used to show the size and distribution of the domains of differing chemistries. It is believed that these domains represent fluorinated and non-fluorinated domains. The domain sizes represent smaller domain sizes than that of previously known fluoropolymer coating compositions which have domain sizes of the order of 1 micrometer to hundreds of micrometers. The relatively small domain size of the current coating composition comprising the fluorine containing graft copolymer is thought to be responsible for the excellent recoat adhesion seen when using the coatings.

The present disclosure also relates to a coating composition whereby a dried and cured layer of the coating composition on a substrate provides the surface of the dried and cured layer of the coating composition with a morphology having a relatively uniformly distributed structure of fluorinated domains and non-fluorinated domains.

### EXAMPLES

Unless otherwise noted, all ingredients are available from the Aldrich Chemical Company, Milwaukee, Wis.

LUPEROX® initiators are available from Arkema Inc., King of Prussia, Pa.

CAPSTONE® monomers, VAZO® initiators, and ZONYL® monomers are all available from DuPont, Wilmington, Del.

BONDERITE® 1000 conversion coating is available from Henkel, Dusseldorf, Germany.

Preparation of Acrylic Polyol

To a 3 liter glass reactor fitted with nitrogen inlet, cold water condenser and electric heating mantle was added 472.9 grams of methyl amyl ketone (MAK). The solvent was heated to reflux at a temperature of 150 to 160° C. A solution of 430.2 grams n-butyl methacrylate, 215.1 grams styrene, 240.2 grams n-butyl acrylate, 548.4 grams 2-hydroxypropyl acrylate, 90.4 grams of LUPEROX® 7M50 initiator and 36.6 grams of MAK was then fed to the reactor over 360 minutes at reflux. Upon completion of this feed a second solution of 3.8 grams t-butylperoxy acetate solution and 83.4 grams of MAK was fed to the reactor over 15 minutes. The mixture was then mixed at reflux for 60 minutes. The resultant polymer solution had a viscosity of 600 to 700 centipoise at 25° C. at 70% weight solids.

Preparation of Comparative Random Fluorinated Acrylic Polyol

To a 3 liter glass reactor fitted with nitrogen inlet, cold water condenser and electric heating mantle are added 472.9 grams of methyl amyl ketone (MAK). The solvent is heated to reflux at a temperature of 150 to 160° C. A solution of 414.4 grams n-butyl methacrylate, 193.6 grams styrene, 216.5 grams n-butyl acrylate, 358.5 grams 2-hydroxypropyl acrylate, 250.9 g CAPSTONE® 62 MA, 90.4 grams of LUPEROX® 7M50 initiator and 36.6 grams of MAK was then fed to the reactor over 360 minutes at reflux. When the addition was complete, a second solution of 3.8 grams t-butylperoxy acetate solution and 83.4 grams of MAK was fed to the reactor over 15 minutes. The mixture was then mixed at reflux for 60 minutes. The resultant polymer solution had a viscosity of 225 to 325 centipoise at 25° C. at 70% weight solids.

Preparation of Fluorinated Acrylic Macromonomer

To a 3 liter glass reactor fitted with nitrogen inlet, cold water condenser and electric heating mantle was added 113.2 grams n-butyl methacrylate, 61.9 grams 2-hydroxypropyl methacrylate, 47.7 grams CAPSTONE® 62 MA, 0.04 grams bis(borondifluoro diphenylglyoximato) cobaltate (II) and 270.5 grams methyl ethyl ketone (MEK). This mixture was heated to reflux at 83 to 88° C. and held at reflux for 20 minutes. 30.24% of a solution of 6.5 grams VAZO® 67 in 70.2 grams of MEK was then fed to the reactor over 10 minutes and the mixture was held at reflux for an additional 10 minutes. The remainder of the VAZO® 67/MEK solution was then fed over 120 minutes simultaneously with 12.5% of a solution of 547.2 grams n-butyl methacrylate, 299.5 grams 2-hydroxypropyl methacrylate, 230.5 grams CAPSTONE® 62 MA and 20.0 grams MEK. This mixture was then held at reflux for an additional 120 minutes after this feed period was complete. The remaining 87.5% of the monomer mixture was then fed over 180 minutes simultaneously with a solution of 19.5 grams LUPEROX® 26 initiator in 313.0 grams MEK. The mixture was then held at reflux for an additional 120 minutes upon completion of the feeds. The final macromonomer solution had a viscosity of 450 to 550 centipoise at 25° C. at 80% weight solids.

Preparation of Fluorine Containing Graft Copolymer #1

To a 3 liter glass reactor fitted with nitrogen inlet, cold water condenser and electric heating mantle was added 406.1 g methyl amyl ketone (MAK). The solvent was heated to reflux at 150 to 160° C. A solution of 390.9 grams of the fluorinated acrylic macromonomer, 404.6 grams of n-butyl methacrylate, 160.3 grams styrene, 179.1 grams n-butyl methacrylate, 258.7 grams 2-hydroxypropyl acrylate, 66.4 grams CAPSTONE® 62MA, 56.5 grams LUPEROX® 7M50 and 25 grams MAK was then fed to the reactor over 360 minutes at reflux. Upon completion of this feed a second solution of 2.4 grams LUPEROX® 7M50 in 50 grams of MAK was fed to the reactor over 15 minutes and the resultant mixture was then held at reflux for an additional 60 minutes. The final polymer solution had a viscosity of 450 to 550 centipoise at 25° C. at 70% weight solids.

Preparation of Acrylic Macromonomer #2

A non-fluorinated acrylic macromonomer was prepared by the procedure shown above for the fluorinated acrylic macromonomer but with the following monomer composition:

222.8 grams n-butyl methacrylate in the initial reactor charge.

1077.2 grams n-butyl methacrylate in feed mixture.

Preparation of Fluorine Containing Graft Copolymer #2

A backbone fluorinated graft copolymer was prepared by the procedure shown for fluorine containing graft copolymer #1 shown above but with acrylic macromonomer #2 shown above and the following monomer composition:
170.2 grams Acrylic Macromonomer #2
241.2 grams CAPSTONE® 62 MA
261.0 grams n-butyl methacrylate
186.2 g styrene
208.0 grams n-butyl acrylate
345.2 grams 2-hydroxypropyl acrylate

Preparation of Comparative Fluorinated Acrylic Copolymer

This copolymer was prepared by procedure described in U.S. Pat. No. 5,629,372 Example 1 but using CAPSTONE® 62 MA in place of ZONYL® fluoromonomer and shows an example of a fluorinated linear polymer that contains a majority of the fluorine containing monomers at the end of the copolymer chain.

TABLE 1

| INGREDIENTS | | | | | | | |
|---|---|---|---|---|---|---|---|
| (all amounts | Example | Example | Example | Example | Example | Example | Example |
| parts by weight) | 1 | 2 | A* | B* | C* | D* | E* |
| Part A | | | | | | | |
| Acrylic Polyol | 53.24 | 53.24 | 53.24 | | 30.31 | 41.87 | 56.05 |
| Fluorine | 2.77 | | | | | | |
| containing | | | | | | | |
| graft | | | | | | | |
| copolymer #1 | | | | | | | |
| Fluorine | | 2.80 | | | | | |
| containing | | | | | | | |
| graft | | | | | | | |
| copolymer #2 | | | | | | | |
| Comparative | | | 2.77 | | | | |
| random | | | | | | | |
| fluorinated | | | | | | | |
| acrylic polyol | | | | | | | |
| Comparative | | | | 56.72 | 26.02 | 14.31 | |
| fluorinated | | | | | | | |
| acrylic | | | | | | | |
| copolymer | | | | | | | |
| Methyl Amyl | 23.40 | 23.34 | 23.40 | 22.68 | 23.07 | 23.21 | 23.35 |
| Ketone | | | | | | | |
| 2% Dibutyltin | 0.59 | 0.59 | 0.59 | 0.61 | 0.61 | 0.61 | 0.61 |
| Dilaurate in | | | | | | | |
| Ethyl Acetate | | | | | | | |
| Part B | | | | | | | |
| DuPont 194S | 28.30 | 28.30 | 28.30 | 28.30 | 28.30 | 28.30 | 28.30 |
| polyisocyanate | | | | | | | |
| solution | | | | | | | |
| Wt % fluorine | 0.275 | 0.500 | 0.500 | 1.09 | 0.500 | 0.275 | 0.000 |
| on total polyol | | | | | | | |
| solids: | | | | | | | |

*Comparative Examples

Parts A of the model clear compositions were prepared by blending the ingredients as shown in the TABLE 1, above. Prior to application, the Part B activator was blended into Part A for each composition. The activated clear compositions were applied by drawn down application to achieve approximately 2 mils dry film thickness to 10 cm×30.5 cm cold rolled steel panels pretreated with BONDERITE® 1000, available from Henkel. After a 15 minute flash, the panels were baked for 30 minutes at 127° C. Following the bake, the panels were placed at room temperature overnight. The following day, in order to test the recoat adhesion properties, the panels were recoated by forming a mixture of the parts A and B from TABLE 1 above using the drawn down application method at right angles to the first application direction and baked for 30 minutes at 127° C.

On the following day, intercoat adhesion was evaluated by cutting an X through the recoated films and recording 1) any observed lift at the cut boundaries and 2) adhesion by lateral knife scrape. Ratings for the two tests were: Good for no lift on cutting and no delamination by knife scrape; Fair for slight lift on cutting and slight intercoat delamination by knife scrape; Poor for severe lift on cutting and severe delamination by knife scrape.

As a measure of potential cleanability, the geometric mean surface energy was determined based on contact angle measurements with water and diiodomethane. The method of Owen, Wendt, Rabel, and Kaelble (AST Products, Inc., Billerica, Mass.) was used in the calculation.

TABLE 2

| Test Results for clears | | | | | | |
|---|---|---|---|---|---|---|
| Example | Example | Example | Example | Example | Example | Example |
| 1 | 2 | A* | B* | C* | D* | E* |

Clear-to-Clear Adhesion

| | | | | | | | |
|---|---|---|---|---|---|---|---|
| Lift on | good | good | good | fair | fair | fair | good |
| initial cut | | | | | | | |
| Knife Scrape | good | good | good | poor | fair | fair | good |

Clear-to-Steel Adhesion

| | | | | | | | |
|---|---|---|---|---|---|---|---|
| Lift on | good | good | good | good | good | good | good |
| initial cut | | | | | | | |
| Knife Scrape | good | good | good | good | good | good | good |
| Geometric | 21.7 | 19.3 | 19.5 | 15.6 | 16.6 | 16.1 | 40.4 |
| Mean | | | | | | | |
| Surface | | | | | | | |
| Energy (mN/m) | | | | | | | |

*Comparative Examples

What is claimed is:

1. A coating composition comprising A) a fluorine containing graft copolymer wherein the fluorine containing graft copolymer comprises:
i) in the range of from 0.5 to 20 percent by weight of fluorine, based on the total weight of the fluorine containing graft copolymer,
ii) in the range of from 0 to 100 percent by weight of fluorine on the side chains, based on the total weight of fluorine in the fluorine containing graft copolymer,
iii) in the range of from 10 to 100 percent by weight of hydroxyl groups on the backbone, based on the total weight of hydroxyl groups in the fluorine containing graft copolymer, and
iv) in the range of from 5 to 50 percent by weight of side chains based on the total weight of the fluorine containing graft copolymer.

2. The coating composition of claim 1 wherein the coating composition further comprises:
B) a copolymer that is different from A).

3. The coating composition of claim 1 wherein the coating composition further comprises a crosslinking component wherein the crosslinking component is selected from the group consisting of a polyisocyanate, a blocked polyisocyanate, an amino resin, a carboxyl containing compound, an epoxy containing compound, a silane containing compound and a combination thereof.

4. The coating composition of claim 2 wherein the coating composition further comprises a crosslinking component wherein the crosslinking component is selected from the group consisting of a polyisocyanate, a blocked polyisocyanate, an amino resin, a carboxyl containing compound, an epoxy containing compound, a silane containing compound and a combination thereof.

5. The coating composition of claim 1, wherein the fluorine containing graft copolymer is produced by the polymerization of monomer mixture, wherein said monomer mixture comprises a fluorine containing macromonomer, fluorine containing monomers and hydroxyl group containing monomers.

6. The coating composition of claim 5 wherein the fluorine containing macromonomer has a weight average molecular weight in the range of from 1,500 to 10,000.

7. The coating composition of claim 1 wherein the fluorine containing graft copolymer has a weight average molecular weight in the range of from 3,000 to 100,000.

8. The coating composition of claim 5 wherein the fluorine containing macromonomer is produced by the polymerization of fluorine containing monomers having structure (I):
CH₂═CR—C(O)O—(CH₂)ₙ—R_{f} (I)
wherein R is hydrogen or methyl, n is an integer in the range of from 0 to 20, and R_{f} is a fluoroalkyl group having in the range of from 1 to 20 carbon atoms.

9. The coating composition of claim 8 wherein R is methyl, n is 2 and R_{f} is —C₆F₁₃.

10. The coating composition of claim 2 wherein the weight ratio of A:B is in the range of from 1:99 to 99:1.

11. A coating composition whereby a dried and cured layer of the coating composition on a substrate provides the surface of the dried and cured layer of the coating composition with a morphology having a relatively uniformly distributed structure of fluorinated domains and non fluorinated domains.

12. The coating composition of claim 11 wherein the relatively uniformly distributed structures have an average diameter in the range of from 25 nanometers to 250 nanometers.
